(19) United States
(12) Patent Application Publication
(10) Pub. No.: US 2013/0278402 A1
(43) Pub. Date: Oct. 24, 2013

(54) EXTERNALLY VIEWABLE FUEL LEVEL MONITOR ON A VEHICLE

(71) Applicant: LEIGH M. ROTHSCHILD, SUNNY ISLES BEACH, FL (US)

(72) Inventor: LEIGH M. ROTHSCHILD, SUNNY ISLES BEACH, FL (US)

(73) Assignee: ARIEL INVENTIONS, LLC, SUNNY ISLES BEACH, FL (US)

(21) Appl. No.: 13/450,773

(22) Filed: Apr. 19, 2012

(51) Int. Cl. B60Q 1/00

(52) U.S. Cl. 340/425.5

(57) ABSTRACT

Indicating a level of fuel contained in a fuel tank of a vehicle. A signal indicating a level fuel contained in the fuel tank of the vehicle is received from a fuel level sending unit. A visual indicator is presented that indicates the level of fuel, and the visual indicator is clearly visible to a person located outside of the vehicle and the person is adjacent to a fuel receiving nozzle of the vehicle.

### BACKGROUND

One or more embodiments disclosed within this specification relate to vehicle fuel level monitoring.

Automobiles usually include a fuel gauge located within an instrument cluster in the automobile's dashboard. When the vehicles ignition is turned on, the fuel gauge receives a signal from a fuel level sending unit located in the fuel tank that indicates the quantity of fuel contained in the fuel tank, and the fuel gauge displays the fuel level. When the vehicle's ignition is off, the fuel level sending unit typically does not receive power, and thus does not generate a signal. Hence, the fuel gauge does not display the fuel level when the ignition is off.

A typical fuel level sending unit includes a float, usually made of a coated foam substance, which floats on top of the fuel contained in the fuel tank. The float typically is attached to a swing arm, which is attached to a variable resistor. The orientation of the swing arm, and thus the amount of resistance provided by the variable resistor, is directly related to the position of the float. In illustration, when the ignition is on, an input voltage (typically DC voltage) is applied to the variable resistor, and an output voltage from the variable resistor is communicated to the fuel level gauge. This output voltage is variable, based on the amount of resistance provided by the variable resistor, and indicates the current level of fuel contained in the fuel tank.

### BRIEF SUMMARY

One or more embodiments disclosed within this specification relate to a method of indicating a level of fuel contained in a fuel tank of a vehicle. The method can include receiving from a fuel level sending unit a signal indicating a level fuel contained in the fuel tank of the vehicle. The method further can include presenting a visual indicator indicating the level of fuel, wherein the visual indicator is visible to a person located outside of the vehicle while the person is adjacent to a fuel receiving nozzle of the vehicle.

Another embodiment can include a system. The system can include a processor configured to initiate executable operations, including receiving from a fuel level sending unit a signal indicating a level fuel contained in the fuel tank of the vehicle, and presenting a visual indicator indicating the level of fuel, wherein the visual indicator is visible to a person located outside of the vehicle while the person is adjacent to a fuel receiving nozzle of the vehicle.

Another embodiment can include a computer program product that includes a computer-usable storage medium having stored therein computer-usable program instructions for indicating a level of fuel contained in a fuel tank of a vehicle. The computer-usable program instructions, when executed by a computer hardware system, can cause the computer hardware system to perform the various operations and/or functions disclosed within this specification.

### BRIEF DESCRIPTION OF THE SEVERAL VIEWS OF THE DRAWINGS

FIG. 1 is a block diagram illustrating a system for indicating a level of fuel contained in a fuel tank of a vehicle in accordance with one embodiment disclosed within this specification.

FIG. 2 is diagram illustrating a portion of a vehicle that includes the system of FIG. 1 in accordance with one embodiment disclosed within this specification.

FIG. 3 is diagram illustrating a portion of a vehicle that includes the system of FIG. 1 in accordance with one embodiment disclosed within this specification.

FIG. 4 is diagram illustrating a processing system in accordance with one embodiment disclosed within this specification.

FIG. 5 is a flow chart illustrating a method of indicating a level of fuel contained in a fuel tank of a vehicle in accordance with one embodiment disclosed within this specification.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

In accordance with the arrangements described herein, a fuel level monitoring system is incorporated into a vehicle to visually indicate the present level of fuel contained in the vehicle's fuel tank to a person who is located outside the vehicle, for example while the person is standing next to the vehicle and adding fuel to the fuel tank. Such indication can be provided on a window of the vehicle, on the vehicle's fuel door, on the vehicle's fuel receiving nozzle, on an external surface of the vehicle, or in any other manner in which the visual indication is clearly visible to the person while the person is located outside of the vehicle.

A typical fuel pump in a fueling station is configured with an automatic shut-off device that stops pumping fuel into a fuel tank when the fuel pump detects that the fuel tank is full. Sometimes, however, the automatic shut-off device is triggered prematurely before the tank is full. In consequence, a person may believe that his fuel tank is full and cease the fueling operation, only to find, when the person starts his vehicle, that the fuel tank is not full. The fuel level indication provided by the present invention informs the person as to the actual level of fuel contained in the fuel tank. Thus, if the fuel tank is not yet full, the person can again commence pumping fuel into his vehicle knowing that the fuel tank has capacity to receive additional fuel.

In addition to fuel level, other information can be presented. For example the quantity of fuel necessary to fill the fuel tank can be presented, the energy efficiency of the vehicle can be presented, the distance the vehicle can travel based on the present fuel level can be presented, an amount of time the vehicle can operate based on the present fuel level can be presented, and so on.

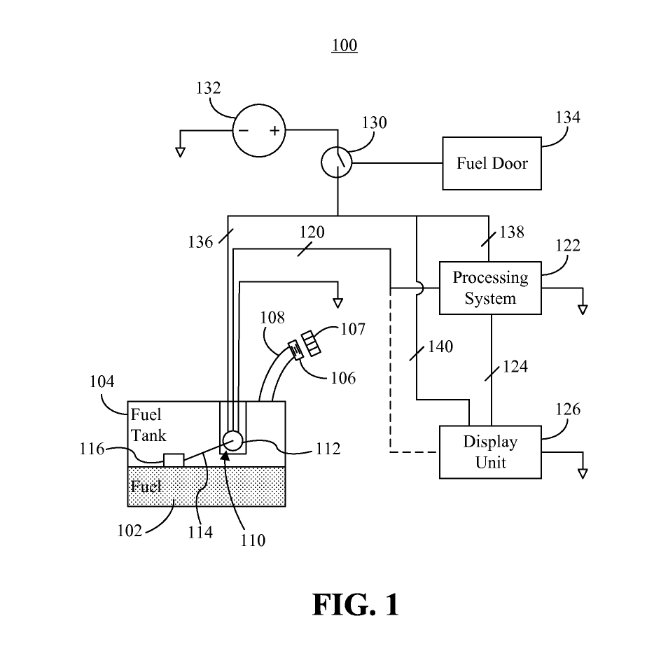

FIG. 1 is a block diagram illustrating a system 100 for indicating a level of fuel contained in a fuel tank of a vehicle in accordance with one embodiment disclosed within this specification. The system 100 can be implemented within a vehicle, such as an automobile, a truck, a tractor, farming equipment, industrial equipment, an aircraft, or the like.

The system 100 can include a fuel level sending unit (hereinafter “sending unit”) 110 that measures a level of fuel 102 within a fuel tank 104. A fuel receiving nozzle 106 through which fuel 102 is added to the fuel tank 104 can be operably connected to the fuel tank 104, for example via a spout 108.

In one non-limiting example, the sending unit 110 can be a conventional sending unit known in the art that comprises a variable resistor 112, a swing arm 114, and a float 116. A first end of the swing arm 114 can be attached to the variable resistor 112 and a second end of the swing arm 114 can be attached to the float 116. The float 116 can be configured to float on top of the fuel 102. An orientation of the swing arm 114 can correspond to the location of the float, and thus the level of fuel 102 contained in the fuel tank 104. The resistance provided by the variable resistor 112 can correspond to the orientation of the swing arm 114. A fuel level signal 120 corresponding to the resistance can be generated by the sending unit 110.

In another example, the sending unit 110 can include an optical sensor that measures the level of fuel 102 contained in the fuel tank 104. In yet another example, the sending unit 110 can include an ultrasonic sensor that measures the level of fuel 102 contained in the fuel tank 104. Still, the system is not limited to these examples; the sending unit 110 can include any sensor(s) or device(s) suitable for measuring the level of fuel 102 contained in the fuel tank 104, and any such sensor(s) or device(s) are within the scope of the disclosed system.

In one embodiment, the sending unit 110 can be configured to communicate the fuel level signal 120 to a processing system 122 to indicate the level of fuel 102 presently contained in the fuel tank 104. As fuel 102 is added to, or removed from, the fuel tank 104, the fuel level signal 120 can continually indicate a present level of fuel 102, even as the level of fuel 102 changes. In other words, as the fuel level increases, the fuel level signal 120 will change accordingly. Similarly, as the fuel level decreases, the fuel level signal 120 will change accordingly. The fuel level signal 120 can be an analog signal (e.g., a DC voltage, an AC voltage, or the like), a digital signal, or any other type of signal suitable for communicating a present level of fuel 102 contained in the fuel tank 104.

The processing system 122 can process the signal 120 and communicate a corresponding signal 124 to a display unit 126, which can present an indication of the present level of fuel 102 in the fuel tank 104. The display unit 126 can comprise a gauge or a display (e.g., LED display, LCD display, plasma display, or the like) that visually presents information, such as the information described herein. In another arrangement, the display unit 126 can project an image comprising such information onto a window or other screen configured to present the information. The invention is not limited in this regard, however. For example, the display unit 126 can interface with any other suitable presentation systems/devices to present the information.

The signals 120, 124 can be communicated via respective wired communication links and/or wireless communication links. Examples of suitable wireless communication links include, but are not limited to, wireless communication links implemented in accordance with a suitable networking protocol (e.g., WiFi®), wireless communication links implemented in accordance with a personal area network (PAN) protocol (e.g., Bluetooth® or ZigBee®), wireless communication links implemented in accordance with a suitable direct wireless communication protocol, wireless communication links implemented in accordance with a suitable infrared (IR) communication protocol, or wireless communication links implemented in accordance with any other suitable protocol.

In another embodiment, the sending unit 110 can be configured to communicate the signal 120 directly to the display unit 126, in which case the display unit 126 can be configured to receive the signal 120 to present the indication of the present level of fuel 102 in the fuel tank 104. Moreover, the processing system 122 and display unit 126 can be embodied as a single device having both processing and display capabilities.

As noted, when a vehicle's ignition is turned off, a typical sending unit does not receive power. Moreover, a vehicle's processing system (e.g., engine control unit (ECU)) also may not receive power when the ignition is turned off. The present invention, however, can provide power to the sending unit 110, the processing system 122 and/or the display unit 126 when it is appropriate to display the fuel level, even while the ignition remains off. For example, the system 100 can include a switch 130 operably connected to a power source, such as a battery 132, that is operable when the vehicle ignition is off.

In one arrangement, the switch 130 can be a mechanical switch physically connected to the fuel door 134 or the fuel receiving nozzle 106. Thus, opening and closing of the fuel door 134 can physically operate the switch, or removing the fuel cap 107 from the fuel receiving nozzle 106, or placing the fuel cap 107 on the fuel receiving nozzle 106, can physically operate the switch. In another arrangement, a sensor (not shown) can be provided to detect when the fuel door 134 is open or closed or when the fuel cap 107 is placed on, or removed from, the fuel receiving nozzle 106. The sensor can communicate a signal to the switch to cause the switch to open or close. Further, the switch can be integrated into the processing system 122. In this regard, the switch 130 can be an electronic switch, such as a transistor, an operational amplifier, or the like.

The switch 130 can be configured to be in an open position (or non-conducting of current) when a fuel door on the vehicle covering the fuel receiving nozzle 106 is closed, or when a fuel cap 107 is positioned on the fuel receiving nozzle 106. The switch 130 can be configured to be in a closed position (or conducting of current) when the fuel door 134 is open, or when a fuel cap 107 is removed from the fuel receiving nozzle 106.

When in the closed position, the switch 130 can close a circuit connection 136 between the battery 132 and the sending unit 110, thereby providing electrical power (hereinafter “power”) to the sending unit. If the processing system 122 normally does not receive power when the vehicle's ignition is off, when in the closed position the switch 130 also can close a circuit connection 138 between the battery 132 and the processing system 122, thereby providing power to the processing system 122. Further, in an arrangement in which the display unit 126 requires power from the battery 132 to operate, when in the closed position, the switch 130 also can close a circuit connection 140 between the battery 132 and the display unit 126, thereby providing power to the display unit 126.

Accordingly, the display unit 126 can present an indication of the present level of fuel 102 in the fuel tank 104 when the vehicle's ignition is off. In illustration, when the fuel door 134 is opened, or when the fuel cap 107 is removed from the fuel receiving nozzle 106, the switch 130 can close to activate the sending unit 110, the processing system 122 and/or the display unit 126.

When activated, the sending unit 110 can communicate the fuel level signal 120 to the processing system, which can process the fuel level signal 120 to communicate a corresponding signal 124 to the display unit 126. In response to receiving the signal 124, the display unit 126 can present a visual indicator indicating the level of fuel 102. In another arrangement, when activated, the sending unit 110 can communicate the fuel level signal 120 directly to the display unit 126. In response to receiving the signal 120, the display unit 126 can present the visual indicator indicating the level of fuel 102. As noted, the visual indicator can be clearly visible to a person located outside of the vehicle while the person is adjacent to a fuel receiving nozzle 106, for instance while the person is adding, is about to add, or has added fuel to the fuel tank 104.

In addition to, or in lieu of, a fuel level indication, tire pressure and/or other information that typically is displayed in modern cars can be presented by the display unit 126. In illustration, the display unit 126 can indicate the quantity, or amount, of fuel necessary to fill the fuel tank 104, the energy efficiency of the vehicle, the approximate distance the vehicle can travel based on the present fuel level, an amount of time the vehicle can operate based on the present fuel level, the quality of fuel recommended for the vehicle (e.g., octane level), and so on. Such information can be determined by the processing system 122 and communicated to the display unit, for example as previously described.

A toggle button, touch screen or sensor can be provided to allow a person to change the information presented by the display unit 126. For example, in one arrangement, if the display unit 126 is accessible to the person while the person is located externally of the vehicle, the display unit 126 can include a toggle button or touch screen that receives tactile inputs from the person to change the information presented by the display unit 126. In another arrangement, the display unit 126 can include an optical sensor (e.g., an imaging device, such as a camera, a motion detector, etc.) that detects gestures provided by the person (e.g., hand or lip movements) to change the information presented by the display unit 126, or an input audio transducer receives spoken utterances generated by the user to change the information presented by the display unit 126. Toggle buttons and touch screens that receive tactile inputs, and sensors that detect gestures and/or spoken utterances, are known in the art.

To determine the quantity of fuel necessary to fill the fuel tank 104, the processing system 122 can, based on the present fuel level indicated by the sending unit 110, determine the quantity of fuel 102 contained in the fuel tank 104. The processing system 122 can subtract a value corresponding to the quantity of fuel 102 from a value corresponding to the total quantity of fuel that the fuel tank 104 is configured to hold. The total quantity of fuel that the fuel tank 104 is configured to hold can be known to the processor 122 a priori. For example, the processing system 122 can be pre-configured to store a value corresponding to the maximum quantity of fuel 102 held by the fuel tank 104 within a suitable data storage device.

To determine a distance-based energy efficiency of the vehicle, the processing system 122 can identify a distance the vehicle has traveled over a particular period and divide that amount by the quantity of fuel consumed by the vehicle over that period. In one arrangement, the period can span a time from when fuel last was added to the fuel tank 104 to a present time, though this need not be the case. The energy efficiency can be identified as a value corresponding to miles per gallon (MPG), kilometers per liter (KPL), miles per liter, kilometers per gallon, or as a value corresponding to any other distance-based fuel efficiency measurement. To determine the distance the vehicle can travel based on the present fuel level, the processing system 122 can multiply the value corresponding to the total quantity of fuel 102 presently contained in the fuel tank 104 by a value corresponding to the vehicles distance-based energy efficiency.

To determine a time-based energy efficiency of the vehicle, the processing system 122 can identify the time the vehicle has been operated over a particular period and divide the quantity of fuel consumed by the vehicle over that period by the identified time. Again, the period can span a time from when fuel last was added to the fuel tank 104 to a present time, though this need not be the case. The energy efficiency can be identified as a value corresponding to gallons per hour (GPH), liters per hour (LPH), or as a value corresponding to any other time-based fuel efficiency measurement. To determine the amount of time the vehicle can operate based on the present fuel level, the processing system 122 can divide the value corresponding to the total quantity of fuel presently contained in the fuel tank 104 by a value corresponding to the vehicles energy efficiency.

The quality of fuel recommended for the vehicle can be known to the processing system 122 a priori. For example, the processing system 122 can be pre-configured and store a value corresponding to such recommendation within a suitable data storage device. That said, the processing system 122, or another processing system within the vehicle (e.g., an ECU or engine management system (EMS) communicatively linked to the processing system 122), may detect an unacceptable level of detonation and/or pre-ignition in the vehicle's engine, for example by processing a signal received from a knock sensor. If detonation and/or pre-ignition is detected, the processing system 122 can increase the value corresponding to the recommended quality of fuel, for example by increasing a recommended fuel octane level to a next higher octane level commonly available in fueling stations.

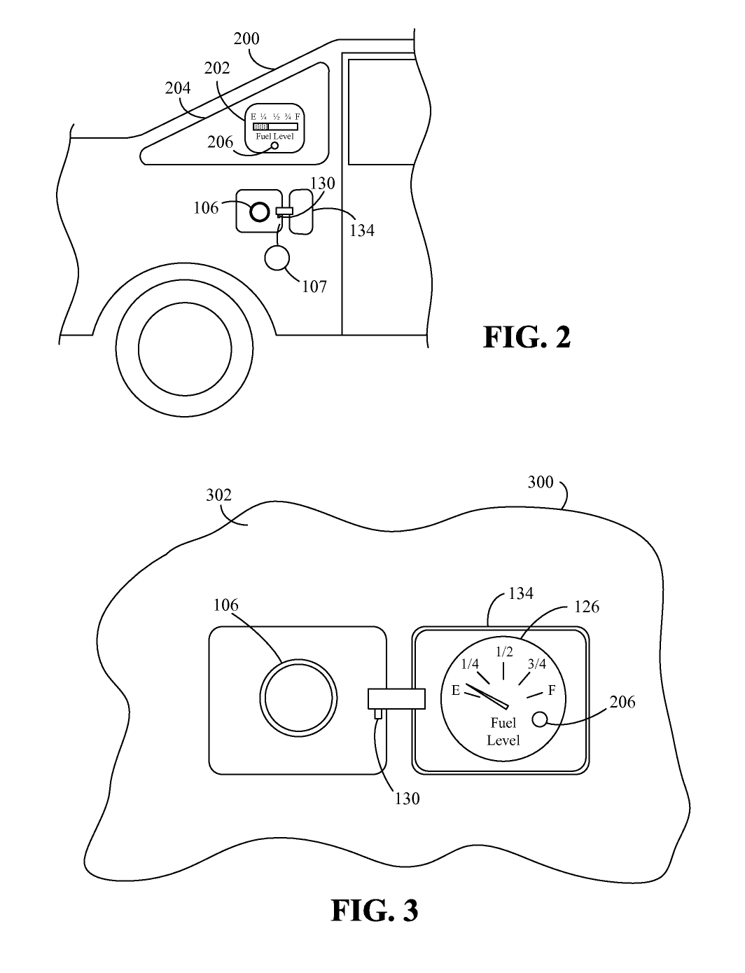

FIG. 2 is diagram illustrating a portion of a vehicle 200 that includes the system of FIG. 1 in accordance with one embodiment disclosed within this specification. As noted, the display unit can present the fuel level indication 202 on a window of the vehicle 200, for example a rear side window or rear quarter window 204 located on a same side of the vehicle 200 as the fuel receiving nozzle 106. The invention is not limited to this example, however. For instance, if the fuel receiving nozzle 106 is located at the front of the vehicle 200, the display unit can present the fuel level indication 202 on a front window (i.e., “windshield”) of the vehicle 200, on a front quarter window or on a front side window. If the fuel receiving nozzle 106 is located at the back side of the vehicle 200, the display unit can present the fuel level indication 202 on the vehicle's rear window. The fuel level indication 202 can be presented when the fuel door 134 is open or when the fuel cap 107 is removed from the fuel receiving nozzle 106. A switch 130, or a sensor operatively connected to a switch, can be provided to detect when the fuel door 134 is open, or when the fuel cap 107 is removed from the fuel receiving nozzle 106.

In one embodiment the display unit can be located proximate to the window 204, for example behind or in front of the window 204, integrated into the window 204, or the display unit can project an image representing the fuel level indication 202 onto the window. As noted, any other suitable information can be displayed on the window 204, such as the quantity of fuel necessary to fill the fuel tank, the energy efficiency of the vehicle, the distance the vehicle can travel based on the present fuel level, an amount of time the vehicle can operate based on the present fuel level, and so on. A toggle button or icon 206 can be presented on the window 204 or the display unit 126 to receive tactile inputs to toggle between the various types of information to be presented by the display unit 126. In illustration, the window 204 can comprise the display unit 126, which can be embodied as a touch screen integrated into the window 204. As also noted, an input audio transducer can be provided to detect spoken utterances provided by a person to toggle between the various types of information to be presented, or optical sensor can be provided to detect lip movements or gestures provided by a person to toggle between the various types of information to be presented.

FIG. 3 is diagram illustrating a portion of a vehicle 300 that includes the system of FIG. 1 in accordance with one embodiment disclosed within this specification. The display unit 126 can be attached to the fuel door 134, or the display unit 126 can be attached to an external surface 302 of the vehicle 300. As noted, the display unit 124 can comprise a gauge or a display. Moreover, a toggle button or icon 206 can be presented on the display unit 126 to receive tactile inputs to toggle between the various types of information to be presented by the display unit 126. Again, an input audio transducer can be provided to detect spoken utterances provided by a person to toggle between the various types of information to be presented, or optical sensor can be provided to detect lip movements or gestures provided by a person to toggle between the various types of information to be presented. Again, a switch 130, or a sensor operatively connected to a switch, can be provided to detect when the fuel door 134 is open, or when the fuel cap 107 is removed from the fuel receiving nozzle 106.

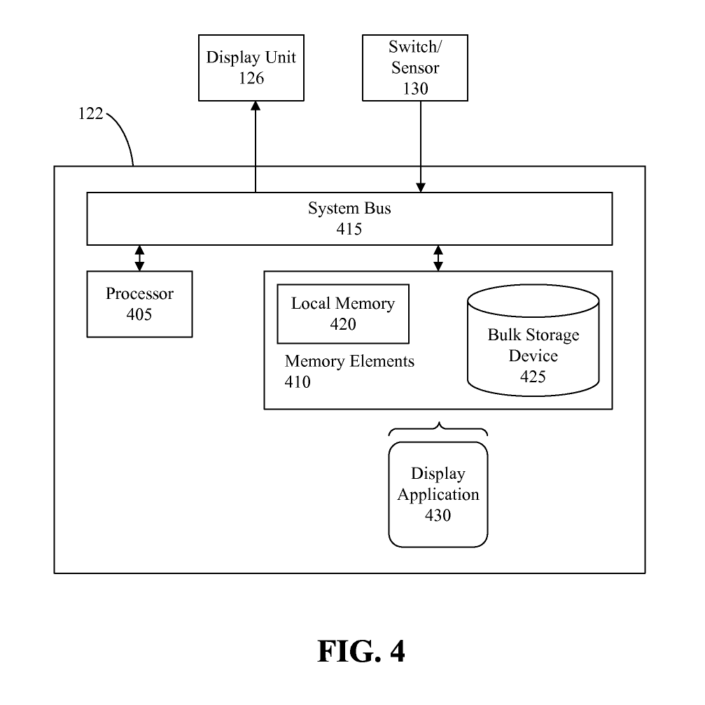

FIG. 4 is diagram illustrating a processing system 122 in accordance with one embodiment disclosed within this specification. The processing system 122 can include at least one processor 405 coupled to memory elements 410 through a system bus 415 or other suitable circuitry. As such, the processing system 122 can store program code within the memory elements 410. The processor 405 can execute the program code accessed from the memory elements 410 via the system bus 415. In one aspect, for example, the processing system 122 can be implemented as a computer that is suitable for storing and/or executing program code. It should be appreciated, however, that the processing system 122 can be implemented in the form of any system including a processor and memory that is capable of performing the functions and/or operations described within this specification.

The memory elements 410 can include one or more computer-usable (e.g., computer-readable) storage devices 410 such as, for example, local memory 420 and one or more bulk storage devices 425. Local memory 420 refers to random access memory or other non-persistent memory device(s) generally used during actual execution of the program code. The bulk storage device(s) 425 can be implemented as read only memory (ROM), a hard disk drive (HDD), a solid state drive (SSD) or other persistent data storage device, an erasable programmable read-only memory (EPROM or Flash memory), a portable compact disc read-only memory (CD-ROM), a digital versatile disc (DVD), an optical storage device, a magnetic storage device, or any suitable combination of the foregoing. The processing system 122 also can include one or more cache memories (not shown) that provide temporary storage of at least some program code in order to reduce the number of times program code must be retrieved from the bulk storage device 425 during execution. In the context of this document, a computer-usable storage device may be any tangible computer-usable storage medium that can contain, or store a program for use by or in connection with an instruction execution system, apparatus, or device. As used herein, a computer-usable device is non-transitory, meaning that it stores computer-usable program code for a finite period.

Input/output (I/O) devices such as the display unit 126 and the switch 130 (or sensor) optionally can be coupled to the processing system 122. The I/O devices can be coupled to the processing system 122 either directly or through intervening I/O controllers.

As pictured in FIG. 4, the computer-usable storage devices 410 can store a display application 430. The display application 430, being implemented in the form of executable program code, can be executed by the processing system 122 and, as such, can be considered part of the processing system 122. In this regard, the display application 430 can be executed by the processor 405 to perform the methods and processes described herein.

As will be appreciated by one skilled in the art, aspects of the present invention may be embodied as a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “system.” Furthermore, aspects of the present invention may take the form of a computer program product embodied in one or more computer-usable storage device(s) having computer-usable program code embodied therewith, e.g., stored, therein or thereon. In this regard, a computer-usable storage device is non-transitory in nature, and distinguished from a transmission medium and/or a transitory signal.

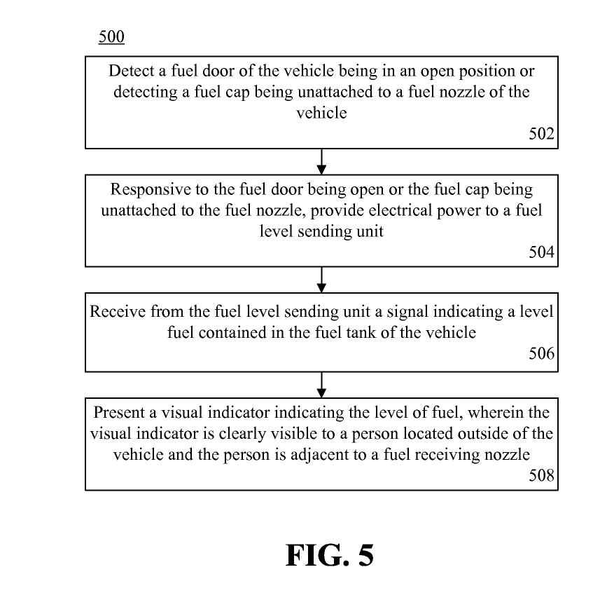

FIG. 5 is a flow chart illustrating a method 500 of indicating a level of fuel contained in a fuel tank of a vehicle, which is useful for understanding the present invention. At step 502, a fuel door of the vehicle being in the open position can be detected or a fuel cap being unattached to a fuel receiving nozzle of the vehicle can be detected. At step 504, responsive to the fuel door being open or the fuel cap being unattached the fuel receiving nozzle, electrical power can be provided to a fuel sending unit. At step 506, a signal indicating a level of fuel contained in a fuel tank of the vehicle can be received from the fuel sending unit. At step 508, a visual indicator indicating the level of fuel can be presented. The visual indicator can be clearly visible to a person located outside of the vehicle while the person is adjacent to a fuel receiving nozzle.

Like numbers have been used to refer to the same items throughout this specification. The flowchart and block diagrams in the Figures illustrate the architecture, functionality, and operation of possible implementations of systems, methods and computer program products according to various embodiments of the present invention. In this regard, each block in the flowchart may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the flowchart illustration, and combinations of blocks in the flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of indicating a level of fuel contained in a fuel tank of a vehicle, the method comprising:
receiving from a fuel level sending unit a signal indicating a level fuel contained in the fuel tank of the vehicle; and
presenting a visual indicator indicating the level of fuel, wherein the visual indicator is visible to a person located outside of the vehicle and the person is adjacent to a fuel receiving nozzle of the vehicle.

2. The method of claim 1, further comprising:
detecting a fuel door of the vehicle being in an open position; and
responsive to the fuel door being open, providing electrical power to the fuel level sending unit while an ignition of the vehicle being off.

3. The method of claim 1, further comprising:
detecting a fuel cap being unattached to a fuel receiving nozzle of the vehicle; and
responsive to the fuel cap being unattached to the fuel receiving nozzle, providing electrical power to the fuel level sending unit while an ignition of the vehicle being off.

4. The method of claim 1, wherein:
the visual indicator is presented on a display unit attached to a fuel door of the vehicle.

5. The method of claim 1, wherein:
the visual indicator is presented on a display unit attached to an external surface of the vehicle.

6. The method of claim 1, wherein:
the visual indicator is presented on a display unit located proximate to, or integrated into, a window of the vehicle.

7. The method of claim 1, wherein:
the presenting includes projecting an image including the visual indicator onto a window of the vehicle.

8. The method of claim 1, wherein:
the visual indicator is presented on a touchscreen.

9. The method of claim 1, further comprising:
presenting additional information to the person, the additional information selected from a group consisting of a quantity of fuel necessary to fill the fuel tank, an energy efficiency of the vehicle, a distance the vehicle can travel based on a present fuel level, and an amount of time the vehicle can operate based on the present fuel level.

10. The method of claim 1, further comprising:
responsive to detonation or pre-ignition being detected while the vehicle operates using a first quality of fuel having a first octane level, presenting to the person an indication recommending second quality of fuel having a second octane level, wherein the second octane level is higher than the first octane level.

11. The method of claim 1, further comprising:
presenting an audible indicator indicating the level of fuel.

12. A system comprising:
a processor configured to initiate executable operations comprising:
receiving from a fuel level sending unit a signal indicating a level fuel contained in the fuel tank of the vehicle; and
presenting a visual indicator indicating the level of fuel, wherein the visual indicator is visible to a person located outside of the vehicle while the person is adjacent to a fuel receiving nozzle of the vehicle.

13. The system of claim 12, further comprising:
a sensor configured to detect a fuel door of the vehicle being in an open position; and
a switch, responsive to the fuel door being open, configured to provide electrical power to the fuel level sending unit while an ignition of the vehicle being off.

14. The system of claim 12, further comprising:
a sensor that detects fuel cap being unattached to a fuel receiving nozzle of the vehicle; and
a switch that, responsive to the fuel cap being unattached to the fuel receiving nozzle, provides electrical power to the fuel level sending unit while an ignition of the vehicle being off.

15. The system of claim 12, further comprising:
a display unit attached to a fuel door of the vehicle that presents the visual indicator.

16. The system of claim 12, further comprising:
a display unit attached to an external surface of the vehicle that presents the visual indicator.

17. The system of claim 12, further comprising:
a display unit located proximate to, or integrated into, a window of the vehicle that presents the visual indicator.

18. The system of claim 12, further comprising:
a display unit that projects an image including the visual indicator onto a window of the vehicle.

19. The system of claim 12, wherein:
the visual indicator is presented on a touchscreen.

20. The system of claim 12, wherein the processor further is configured to initiate executable operations comprising:
presenting additional information to the person, the additional information selected from a group consisting of a quantity of fuel necessary to fill the fuel tank, an energy efficiency of the vehicle, a distance the vehicle can travel based on a present fuel level, and an amount of time the vehicle can operate based on the present fuel level.

21. The system of claim 12, wherein the processor further is configured to initiate executable operations comprising:
responsive to detonation or pre-ignition being detected while the vehicle operates using a first quality of fuel having a first octane level, presenting to the person an indication recommending second quality of fuel having a second octane level, wherein the second octane level is higher than the first octane level.

22. The system of claim 12, wherein the processor further is configured to initiate executable operations comprising:
presenting an audible indicator indicating the level of fuel.

23. A computer program product comprising a computer-usable storage medium having stored therein computer-usable program instructions for indicating a level of fuel contained in a fuel tank of a vehicle, the computer-usable program instructions, which when executed by a computer hardware system, causes the computer hardware system to perform:
receiving from a fuel level sending unit a signal indicating a level fuel contained in the fuel tank of the vehicle; and
presenting a visual indicator indicating the level of fuel, wherein the visual indicator is visible to a person located outside of the vehicle while the person is adjacent to a fuel receiving nozzle of the vehicle.

24. The computer program product of claim 23, wherein the computer-usable instructions, which when executed by the computer hardware system, further causes the computer hardware system to perform:
detecting a fuel door of the vehicle being in an open position; and
responsive to the fuel door being open, providing electrical power to the fuel level sending unit while an ignition of the vehicle being off.

25. The computer program product of claim 23, wherein the computer-usable instructions, which when executed by the computer hardware system, further causes the computer hardware system to perform:
detecting a fuel cap being unattached to a fuel receiving nozzle of the vehicle; and
responsive to the fuel cap being unattached to the fuel receiving nozzle, providing electrical power to the fuel level sending unit while an ignition of the vehicle being off.
